(19) United States
(12) Patent Application Publication
(10) Pub. No.: US 2006/0087242 A1
(43) Pub. Date: Apr. 27, 2006

(54) Low-pressure gas discharge lamp with electron emitter substances similar to batio3

(76) Inventors: Robert Peter Scholl, Roetgen (DE); Rainer Hilbig, Aachen (DE); Bernd Rausenberger, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/526,923

(22) PCT Filed: Aug. 29, 2003
(86) PCT No.: PCT/IB03/03948

§ 371 Date: Mar. 8, 2005

(30) Foreign Application Priority Data
Sep. 12, 2002 (DE) 102-42-241.9

(51) Int. Cl. H01J 17/04; H01J 61/04

(52) U.S. Cl. 313/633; 313/311; 313/346 R

(57) ABSTRACT

A low-pressure gas discharge lamp is described, which is equipped with a gas-discharge vessel containing an inert gas filling as the buffer gas and an indium, thallium and/or copper halide, and with electrodes and with means for generating and maintaining a low-pressure gas discharge, which has as the electron emitter substance a compound selected from the group of ABO₃ or AₙBO₂₊ₙ, AₙC₂O₅₊ₙ, or AₙD₂O₃₊ₙ, wherein: A=an alkaline earth element or a mixture of several different alkaline earth elements, B=cerium, titanium, zirconium, hafnium, or a mixture of these elements, C=vanadium, niobium, tantalum, or a mixture of these elements, D=scandium, yttrium, lanthanum, a rare earth element, or a mixture of these elements.

The invention relates to a low-pressure gas discharge lamp equipped with a gas-discharge vessel containing an inert gas filling as the buffer gas and an indium, thallium, and/or copper halide, and with electrodes and with means for generating and maintaining a low-pressure gas discharge.

The generation of light in low-pressure gas discharge lamps is based on the fact that charge carriers, especially electrons but also ions, are accelerated so strongly by an electrical field between the electrodes of the lamp that, in the gas filling of the lamp, owing to collisions with the gas atoms or molecules of the gas filling, they excite or ionize them. When the atoms or molecules of the gas filling return to their normal state, a part of the excitation energy, which may be greater or smaller, is converted into radiation.

Conventional low-pressure gas discharge lamps contain mercury in the gas filling, and are also equipped with a fluorescent coating internally on the gas-discharge vessel. It is a disadvantage of mercury low-pressure gas discharge lamps that mercury vapor emits radiation primarily in the high-energy but invisible UV-C range of the electromagnetic spectrum, which radiation can be converted into visible radiation, with significantly lower energy, only by using these fluorescent materials. The energy difference is hereby converted into undesirable thermal radiation.

The mercury in the gas filling is also increasingly regarded as an environmentally polluting and toxic substance, which should be avoided where possible in modern mass production owing to the environmental hazard involved in its use, production and disposal.

It is already known that the spectrum of low-pressure gas discharge lamps can be influenced by replacing the mercury in the gas filling with other substances.

For instance, it is already known from German patent submissions 100 44 562 and 100 44 563 that a copper compound or an indium compound can be added to low-pressure gas discharge lamps with a gas filling comprising an inert gas. When standard TL electrodes (tungsten filament with triple oxide emitter (BaO, SrO, CaO)) are used, it transpires hereby, however, that, for example, the indium bromide with the emitter is converted according to the equation BaO+2InBr→BaBr₂+In₂O, with the result that the radiant indium or indium bromide disappears from the discharge.

If lamps with pure tungsten electrodes without an emitter are filled with InBr, although the InBr remains in the discharge, massive sputtering, and consequently blistering, occurs owing to the high work function of the tungsten. Moreover, the efficiency of the discharge is low as the electrode losses dominate owing to the high cathode fall.

It was therefore the object of the invention to create a low-pressure gas discharge lamp that does not exhibit the stated disadvantages, wherein its radiation lies as near as possible to the visible range of the electromagnetic spectrum.

This object is achieved in accordance with the invention by means of a low-pressure gas discharge lamp equipped with a gas-discharge vessel containing an inert gas filling as the buffer gas and an indium, thallium, and/or copper halide, and with electrodes and with means for generating and maintaining a low-pressure gas discharge, in which a compound selected from the group of ABO₃ or AₙBO₂₊ₙ, AₙC₂O₅₊ₙ, or AₙD₂O₃₊ₙ is used as the electron emitter substance, wherein:

A=an alkaline earth element or a mixture of several different alkaline earth elements

B=cerium, titanium, zirconium, hafnium, or a mixture of these elements

C=vanadium, niobium, tantalum, or a mixture of these elements

D=scandium, yttrium, lanthanum, a rare earth element, or a mixture of these elements.

Surprisingly, it transpires that the electron emitter substances similar to BaTiO₃ do not react with indium, thallium or copper halides under lamp conditions. This has been demonstrated in experiments in which BaTiO₃ “electrodes” were used in cold cathode lamps (diameter of the approximately 40 cm long cylindrical burner was approximately 3.5 mm) instead of the usual metallic electrodes as coupling structures of the lamps (operating frequency used: either 50 kHz or 13.56 MHz). No reactions, or at least scarcely perceptible reactions, of the molecular indium, thallium or copper halide lamp fillings hereby occur with the compounds used as electron emitter substances in accordance with the invention.

The compounds used as electron emitter substances in accordance with the invention are here designated substances similar to BaTiO₃ for short.

In the lamp in accordance with the invention, a molecular gas discharge takes place at low pressure, emitting radiation in the visible and near UVA range of the electromagnetic spectrum. When copper halides are used, the radiation contains, in addition to the characteristic lines for copper at 325, 327, 510, 570 and 578 nm, a broad continuum in the blue range of the electromagnetic spectrum from 400 to 550 nm. If an indium halide is used instead, a broad continuum in the range from 320 to 450 nm is observed in addition to the characteristic lines for indium at 410 and 451 nm. Since this is the radiation from a molecular discharge, the precise position of the continuum can be controlled by means of the nature of the copper, thallium or indium halides, any further additives and the internal lamp pressure and operating temperature.

Combined with fluorescent materials, the lamp in accordance with the invention has a visual efficiency that is considerably higher than that of conventional low-pressure mercury discharge lamps. The visual efficiency, expressed in lumen/watt, is the ratio between the brightness of the radiation in a certain visible wavelength range and the generation energy for the radiation. The high visual efficiency of the lamp in accordance with the invention means that a certain quantity of light is realized through lower power consumption.

In the simplest case, the gas filling comprises an indium, thallium and/or copper halide in a quantity of 1 to 10 μg/cm³ and an inert gas. The inert gas serves as a buffer gas and facilitates the ignition of the gas discharge. The preferred buffer gas is argon. Argon may be replaced, either wholly or partially, by another inert gas such as helium, neon, krypton or xenon.

The efficiency can be further improved if the internal operational pressure of the lamp is optimized. The cold-fill pressure of the buffer gas is 10 mbar max. A range between 1.0 and 2.5 mbar is preferred.

A further advantageous measure to increase the lumen efficiency of the low-pressure gas discharge lamp in accordance with the invention has proved to be the control of the operating temperature of the lamp through suitable design measures. The diameter and length of the lamp are selected such that, with an external temperature of 25° C., an internal temperature of 170 to 285° C. is reached during operation. The internal temperature is referred to the coldest location of the gas discharge vessel, since a temperature gradient occurs in the vessel as a result of the discharge.

In order to increase the internal temperature, the gas discharge vessel may also be coated with a coating reflecting IR radiation. A coating comprising indium-doped tin oxide reflecting infrared radiation is preferred.

It must be emphasized that the electron emitter substances ABO₃ or AₙBO₂₊ₙ, AₙC₂O₅₊ₙ or AₙD₂O₃₊ₙ, can easily be reduced in operation, so that these substances are present as ABO_{3-ε}, AₙBO₂₊ₙ₋, AₙC₂O_{5+n-ε} or AₙD₂O_{3+n-ε} after a burning-in time. In these reduced compounds, ε means a small number between 0 and 1. The slightly reduced electron emitter substances can, of course, also be used directly.

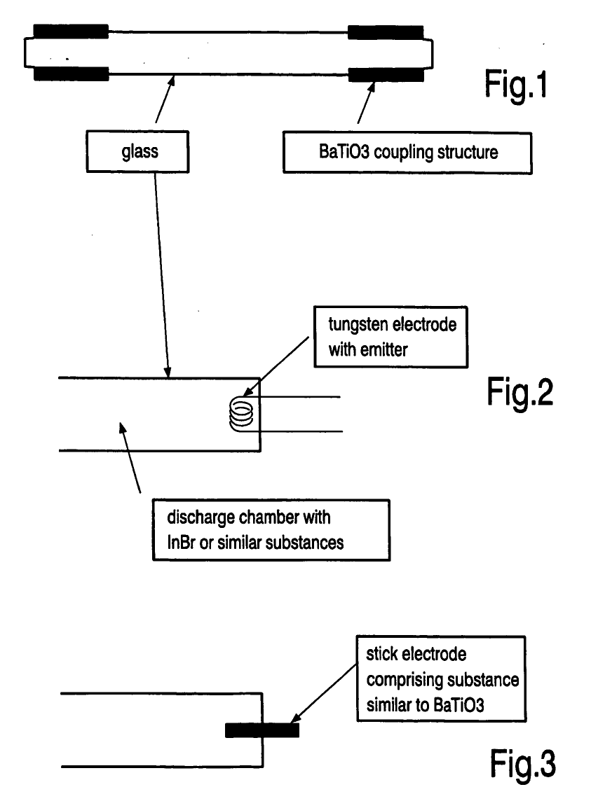

Like BaTiO₃ or similar substances, the electron emitter substances in accordance with the invention may hereby serve as the coupling structure for a capacitive operation of a molecular indium, thallium or copper halide, as shown in FIG. 1. However, the emitter substance in accordance with the invention may also be used on a tungsten electrode, as shown in FIG. 2. Finally, the emitter substances in accordance with the invention may also themselves be used as electrode materials (without tungsten wire). This so-called stick electrode (FIG. 3) must then be rendered conductive by means of ancillary substances. Jointly sintered barium titanate and metallic tungsten are suitable for this purpose.

The particular advantage of the electron emitter substances in accordance with the invention lies in the fact that only a low work function is required for the electron release.

One possible embodiment of the low-pressure gas discharge lamp in accordance with the invention consists in its being coated on its external surface with a fluorescent coating. The emitted UV radiation of the gas discharge excites the fluorescent materials in the fluorescent coating to emit light in the visible range. The chemical composition of the fluorescent coating determines the spectrum of the light and its hue. The materials that can be used as fluorescent materials must absorb the generated UV radiation and must emit in a suitable wavelength range, for example for the three primary colors red, blue and green, and achieve a high fluorescence quantum yield.

However, suitable fluorescent materials and combinations of fluorescent materials do not have to be applied to the interior of the gas discharge vessel, but may also be applied to the exterior, since the generated radiation in the UVA range is not absorbed by the normal types of glass.

One advantageous use for the lamp in accordance with the invention is its application as a UVA lamp for sunbeds, disinfection lamps and paint curing lamps. For general lighting purposes, the lamp is combined with appropriate fluorescent materials. Because the losses from the Stokes Shift are low, visible light is obtained with a high light yield of more than 100 lumen/watt.

1. A low-pressure gas discharge lamp equipped with a gas-discharge vessel containing an inert gas filling as the buffer gas and an indium, thallium, and/or copper halide, and with electrodes and with means for generating and maintaining a low-pressure gas discharge, characterized in that a compound selected from the group of ABO₃ or AₙBO₂₊ₙ, AₙC₂O₅₊ₙ, or AₙD₂O₃₊ₙ is used as the electron emitter substance, wherein:
A=an alkaline earth element or a mixture of several different alkaline earth elements
B=cerium, titanium, zirconium, hafnium, or a mixture of these elements
C=vanadium, niobium, tantalum, or a mixture of these elements
D=scandium, yttrium, lanthanum, a rare earth element, or a mixture of these elements.

2. A low-pressure gas discharge lamp as claimed in claim 1, characterized in that a reduced emitter substance selected from the group of ABO_{3-ε}, AₙBO_{2+n-ε}, AₙC₂O_{5+n-ε} or AₙD₂O_{3+n-ε} is used as the electron emitter substance, wherein e represents a small number between 0 and 1.

3. A low-pressure gas discharge lamp as claimed in claim 1, characterized in that it contains an inert gas from the group of helium, neon, argon, krypton, and/or xenon as the buffer gas.

4. A low-pressure gas discharge lamp as claimed in claim 1, characterized in that the gas discharge vessel is coated with a fluorescent coating on its interior and/or exterior.

5. A use of the electron emitter substance as claimed in claim 1 as the coupling structure for a capacitive operation of a molecular indium halide, thallium halide, or copper halide discharge.

6. A use of the electron emitter substance as claimed in claim 1 as the emitter on a tungsten electrode.

7. A use of the electron emitter substance as claimed in claim 1 as the electrode material that has been rendered conductive by means of additives.
